(19) United States
(12) Patent Application Publication
(10) Pub. No.: US 2002/0133587 A1
(43) Pub. Date: Sep. 19, 2002

(54) System for monitoring telecommunication network and training statistical estimator

(76) Inventors: Christian Ensel, Munchen (DE); Volkmar Sterzing, Neubiberg (DE)

Correspondence Address: STAAS & HALSEY LLP, 700 11TH STREET, NW, SUITE 500, WASHINGTON, DC, 20001, US

(21) Appl. No.: 10/042,278

(22) Filed: Jan. 11, 2002

(30) Foreign Application Priority Data
Jan. 12, 2001 (DE) 101 01 286.1

(51) Int. Cl. G06F 15/173

(52) U.S. Cl. 709/224

(57) ABSTRACT

Activity parameters which describe the activity of the respective device are determined of at least some of the devices and/or services. The communication parameters determined are compared with a normal range of dependence determined from dependences determined between the devices by a trained statistical estimator, and it is determined whether the communication performance of the devices meets a predetermined criterion.

### CROSS REFERENCE TO RELATED APPLICATIONS

This application is based on and hereby claims priority to German Patent Application No. 10101286.1 filed on Jan. 12, 2001, the contents of which are hereby incorporated by reference.

### BACKGROUND OF THE INVENTION

1. Field of the Invention

The invention relates to a method and a device for the computer-aided monitoring of a telecommunication network and to a method for the computer-aided training of a statistical estimator for monitoring a telecommunication network.

2. Description of the Related Art

In a conventional telecommunication network, for example the Internet, a multiplicity of quite different devices capable of communication are networked, that is to say coupled to one another.

In this connection, a telecommunication network is understood to be a communication network by which different electronic devices can communicate with one another, for example

a communication network which provides for communication according to the Internet protocols,

a Local Area Network (LAN),

a public communication network, which is also called Wide Area Network (WAN),

a radio network, for example according to the GSM standard or the UMTS standard.

In such an inhomogeneous communication network, that is to say in a communication network having a great number of different electronic devices which are not based on the same operating system, communication mechanism, etc., there is frequently a requirement for administering and/or monitoring these devices jointly, for example with regard to a failure of one of the devices coupled to one another in the communication network or with regard to different penetration attempts or attempted attacks which represent an unauthorized penetration into the stored data of such a device.

Due to the multiplicity of different types of devices coupled to one another by the communication network, for example

switching units

terminals capable of communication such as

printers,

server computers,

workstations,

personal computers,

laptops,

personal digital assistants (PDAs), etc.,

and due to the complexity of the different types of communication links between the individual devices which can be based on different communication standards, i.e. communication protocols, it is at present possible to administer and to monitor devices in a telecommunication network centrally and in an automated manner to only a very restricted extent.

Furthermore, there is frequently a requirement for administering and/or monitoring not only the devices themselves but also services, that is to say, in the sense of the further description, for example, application programs in a state of execution such as, for example, a web server, a file server, databases, various application servers or X11 terminals which also communicate with one another via the telecommunication network.

Due to an inadequate automated central monitoring capability at present, it is possible to detect a failure or an attempted attack on a device and/or a service, and to respond in time to such a failure or attempted attack, only with difficulty, if at all.

Furthermore, a failure or an attempted attack on a device or a service frequently generates a very large number of error messages which can be detected and analyzed with regard to the underlying cause of the error or cause of the attack only with difficulty.

In currently known management tools for eliminating disturbances in the communication network, there is no systematic monitoring of the telecommunication network with regard to noticeable or questionable activities with regard to security of components in the telecommunication network which is based on an overview of the communication network.

Furthermore, at the OSI layer 2 and OSI layer 3 level in the Open System Interconnection reference model (OSI reference model) of the International Organization for Standardization (ISO), there are capabilities for detecting the topology and the structure of interconnected communication devices in a telecommunication network, which capabilities are restricted to different communication protocols.

However, this detection, which is basically restricted to existing structures, does not allow any conclusions with regard to actual relations between the individual devices in the telecommunication network in the sense of the active performance of the individual devices and/or the services used and their utilization.

Neither is it possible to extract these relations automatically to a sufficiently large extent in accordance with the known communication protocols.

At the level of higher OSI layers, for example the presentation layer (OSI layer 6) or the application layer (OSI layer 7) of the OSI reference model, at which usually the application programs are implemented, the individual interrelationships between the communication devices or, respectively, the services used are input manually in accordance with the prior art and formulated in accordance with the protocol format used in different languages and forms of representation.

However, this procedure is not suitable for use in a real, relatively large telecommunication network due to the lack of a uniform general description of the structure of the telecommunication network.

It is particularly in the case of an increased number of devices and/or services which communicate with one another via the telecommunication network that manual monitoring of the individual devices or services in the telecommunication network is no longer practicable or, respectively, no longer possible at all.

### SUMMARY OF THE INVENTION

The invention is thus based on the object of monitoring devices capable of communication, and/or services which communicate with one another via a telecommunication network, in an automated manner and in a simpler manner compared with the prior art.

The object is achieved by a method for computer-aided monitoring of a telecommunication network formed of devices capable of communication, including determining activity parameters, each describing activity of at least one of a corresponding device and a corresponding service; comparing the activity parameters by a statistical estimator trained with training data and having a normal range of dependence based on dependences determined between the devices; and determining from said comparing whether at least one of the devices and services in the telecommunication network has a communication performance different from the normal range of dependence in accordance with a predetermined criterion

In a method for the computer-aided monitoring of a telecommunication network which has a multiplicity of devices capable of communication and/or services, at least some of the devices or services, respectively, determine communication parameters which describe the activity of the respective device or service, respectively.

In this connection, activity of a device or of a service, respectively, is understood to be, for example, the computer utilization of a processor exhibited by the device or which executes the service, or else the communication activity with other devices or services, respectively, via the communication network, that is to say the degree of sending and receiving of data, preferably of digital data which are grouped in data packets.

The communication parameters determined are compared by a statistical estimator, trained with training data, with a normal range of dependence determined from the dependences determined between the devices, and, from the comparison, a determination is made as to whether the communication performance of one or more devices or services, which are connected to the telecommunication network, differs from their normal performance, that is to say from their undisturbed performance in accordance with a predetermined criterion, for example by a predetermined range of tolerances.

In other words, this means that a determination is made as to whether one or more devices or services differ in a predetermined manner in their performance with regard to a predetermined comparison criterion compared with the normal range of dependence previously determined.

In a method for the computer-aided training of a computer-aided estimator which is used for monitoring a telecommunication network formed of a multiplicity of devices capable of communication and/or services, communication parameters which describe the activity of the respective device or service are determined by at least some of the devices and/or services.

From the activity data, also called activity parameters in the text which follows, that is to say the communication parameters or, respectively, the computer utilization of the devices or services, possible dependences between the devices or services with respect to their communication with one another are determined and, from the dependences determined, a normal range of dependence is determined by which dependences between the devices or services essential without disturbance of the devices or services and without attempted attacks of a device or by a device or, respectively, of a service or by a service, are described.

The statistical estimator is trained with the usual performance of the devices or services, that is to say with the normal range of dependence.

A device for the computer-aided monitoring of a telecommunication network formed of a multiplicity of devices capable of communication has a processor for performing both the method for monitoring and the method for training the statistical estimator for monitoring the devices capable of communication which are coupled to the telecommunication network.

Furthermore, computer programs for the computer-aided monitoring of a telecommunication network and for training a statistical estimator for monitoring a telecommunication network which, when they are executed by a processor, have the method steps, described above, of the corresponding methods, are stored in computer-readable storage media.

Furthermore, computer program elements for the computer-aided monitoring of the telecommunication network and for the computer-aided training of a statistical estimator for monitoring a telecommunication network have the method steps, described above, of the corresponding methods when they are executed by a processor.

The invention makes it possible for the first time to monitor a multiplicity of the most varied devices or services with regard to their failures or with respect to possible attempted attacks at the level of the application layer or of the presentation layer of the OSI reference model even though the individual devices or services coupled to the telecommunication network operate very inhomogeneously, that is to say by the most varied protocols in different layers of the OSI reference model.

A further considerable advantage of the invention can be seen in the fact that the dependences of the individual devices on one another can also be taken into consideration in an automated manner, even in pairs according to one embodiment of the invention, and can thus be included in the automated monitoring.

This makes it possible to perform the monitoring of devices and services very efficiently automatically and thus inexpensively.

Furthermore, the automated monitoring is considerably improved and made more efficient particularly by an analysis, based on statistical methods, of large volumes of data produced with regard to a possible cause of an error or, respectively, a possible attempted attack.

At least some of the devices can be constructed as terminals capable of communication.

The activity parameters can be determined within a predetermined time interval which can be the same or different for all or at least some of the devices in the communication network.

This also makes it possible to change the performance of the individual devices or services in time, particularly with regard to the communication activity of the individual devices or services, which further improves the accuracy of the monitoring.

According to a further embodiment of the invention, it is provided that the activity parameters are determined by the respective device itself and the activity parameters determined are transmitted to a central administration unit in which the further method steps are carried out.

According to a further development of the invention, for example, it is provided that the activity parameters determined are stored by using a network management protocol, for example by the Simple Network Management Protocol (SNMP) in a Management Information Base (MIB) and, correspondingly, the activity parameters are interrogated from the MIB by the administration unit in accordance with the SNMP protocol and are transmitted to the administration unit.

According to an alternative embodiment of the invention, it is provided that the activity parameters are determined by an activity parameter determining unit outside the respective device, that is to say, for example, by a switching unit which determines different communication parameters at an external interface of the respective device.

In the case where the activity parameters are, for example, the number of data packets transmitted or received by the respective device, the number of data packets determined by the switching unit directly coupled to the respective device is used as communication parameter.

The dependences can be communication-related dependences between the devices or services which, according to one embodiment of the invention, can have a directional dependence with regard to the direction of communication between the individual devices or services, respectively.

A directional dependence is understood to mean, for example, that a distinction is made as to whether a device or a service is transmitting or receiving a message or a data packet.

This further development further improves the accuracy of the monitoring of the devices or services in the telecommunication network since an additional parameter, namely the directional dependence information, is taken into consideration.

The data determined directly from the communication data can be subjected to preprocessing of different types, for example filtering or a statistical preanalysis, and, from the preprocessed data, the communication parameters can be determined which are used directly for the monitoring.

The preprocessing achieves a further increase in efficiency of the monitoring.

In each case, paired dependences can be determined for in each case one pair of devices or one pair of services, that is to say the activity parameters can be determined in each case for all possible combinations of two devices or services coupled to one another in the telecommunication network, in particular for the communication-related dependence between the devices.

This makes it possible to consider the dependences in pairs and thus further simplifies the determination of possible causes of error.

According to a further embodiment of the invention, it is provided that the activity parameters determined for the device pairs or service pairs are stored in the form of a matrix and that the normal range of dependence is determined from the structure of the matrix determined.

Thus, a structural dependence is determined between the individual rows or columns of a matrix in which the respective dependences are specified, that is to say, for example, the communication between the individual devices or services which in each case represent a row or a column, respectively, of the matrix.

The structure of the matrix formed is “learnt” by the statistical estimator and, during the application phase, an essentially graphical and thus very simple structural monitoring is effected by the statistical estimator during the monitoring of the respective devices.

The activity parameters can be, for example, one of the following parameters:

a number of the data packets sent by the respective device or service or of the data packets received by the respective device or service,

the processor utilization of the respective device,

the number of predetermined system function calls, for example of operating system functions of the operating system which uses the respective device capable of communication or which performs the respective service,

the existence of predetermined processes or of predetermined computer programs during the period during which the communication parameters for the respective device or the respective service are determined.

The statistical estimator used can be, for example, a basically arbitrary neural model, that is to say a neural network, or else a neuro-fuzzy model, which is trained by known training methods and possibly additionally by so-called pruning methods.

In the case where the performance of at least one device or service in the telecommunication network differs to a predefined extent from the criterion with regard to the normal range of dependence, an alarm signal is generated and displayed to a user of the monitoring system, for example as an audio signal or else as a graphical alarm signal on a screen.

In this manner, the administrator of a telecommunication network is provided in an automated manner with a warning that, with a correspondingly high probability, there is a device or service in the telecommunication network which is disturbed or even has failed or which is starting an attempted attack on another device or on another service or which itself is being attacked by an unauthorized access attempt.

In this connection it should be noted that the training of the statistical estimator can take place both off-line or also additionally or alternatively on-line, that is to say during the application phase, during which the telecommunication network is already being monitored.

According to an alternative embodiment, it is also provided to construct the statistical estimator as one or more pulsed neurons which are coupled to one another.

Thus, the invention can be used both for determining a defect by a device or service in the telecommunication network and/or for determining an unauthorized attempt at accessing to or by a device/service in the telecommunication network.

The embodiments of the invention shown above relate both to the methods, the devices and the computer-readable storage media and the computer program elements.

The invention can be implemented by a special electronic circuit, i.e. in hardware, and by a computer program, i.e. in software.

### BRIEF DESCRIPTION OF THE DRAWINGS

Further significant and advantageous features of the invention emerge from the description of an exemplary embodiment, using the drawings, wherein:

FIG. 1 graphic schematic of a telecommunication network according to an exemplary embodiment of the invention;

FIG. 2 is a block diagram of a neural model which represents the dependence of the activity parameters between two devices capable of communication according to an exemplary embodiment of the invention;

FIG. 3 is a graphic representation of a comparison of two matrices indicating dependences of the activity parameters between respective devices in a telecommunication network;

FIG. 4 is a flowchart of a method according to an exemplary embodiment of the invention.

### DETAILED DESCRIPTION OF THE PREFERRED EMBODIMENT

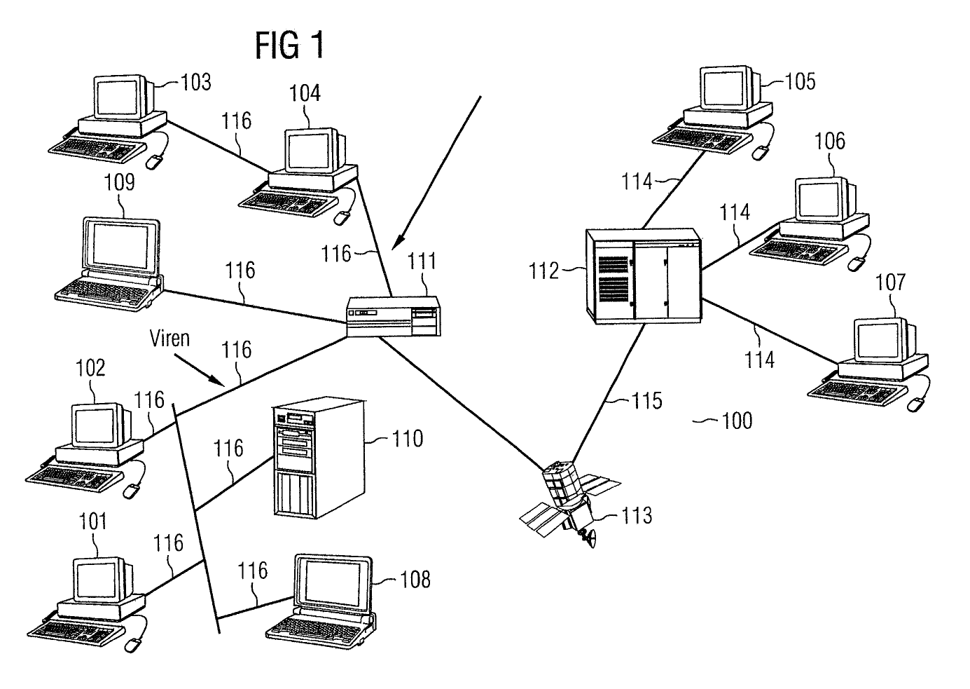

FIG. 1 shows a telecommunication network 100 with a multiplicity of devices capable of communication such as personal computers 101, 102, 103, 104, terminals 105, 106, 107, laptops 108, 109, a workstation 110, a firewall computer 111 and a central computer 112, which are coupled to one another and to a central administration computer 113 via the telecommunication network 100.

The terminals 105, 106, 107 are coupled to the central computer 112 via lines 114 and to the central administration computer 113 via a local area network 115.

Furthermore, the personal computers 101, 102, 103, 104, the laptops 108, 109 and the workstation 110 are coupled to the central administration computer 113 by communication links 116 and using the Internet protocol via the firewall computer 111.

The devices capable of communication and coupled to one another by the telecommunication network 113 are monitored in accordance with the method described in the text which follows, by the central administration computer 113 as the central administration unit.

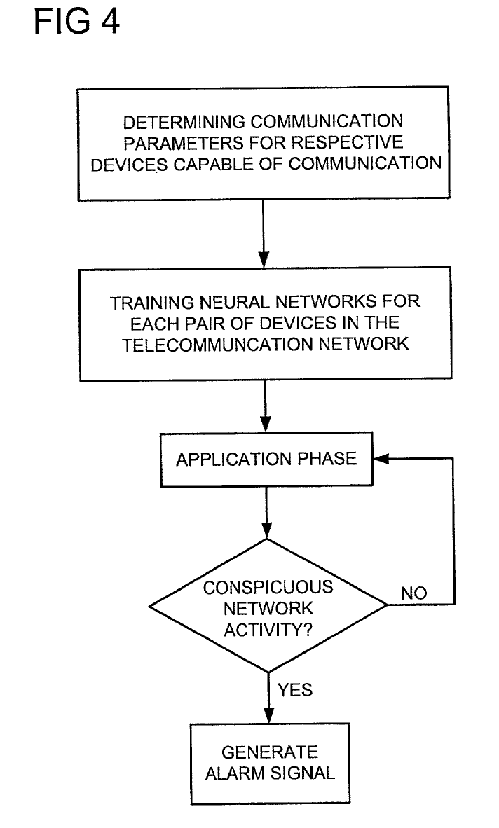

As explained in detail in the text which follows, the individual communication parameters for the respective devices capable of communication are determined in a first step (step 401) as shown in the flowchart 400 in FIG. 4.

According to the exemplary embodiment, the following quantities, describing the activity of the respective devices in the telecommunication network 100, are determined as activity parameters with regard to the data traffic between in each case one pair of devices, that is to say in each case two devices within the telecommunication network 100.

In a training phase, in each case only data for the traffic between two devices are selected and various predetermined application programs, for example typical application programs such as a web server program or an X application are started and executed, all remaining devices in the telecommunication network 100 being switched off or the data for the traffic between the two specific devices being able to be isolated, for example by the IP (Internet Protocol) addresses.

Thus, in a digital data exchange, only the communication generated directly due to the applications executed or the services performed, or, respectively, the utilization of the respective device, and possibly a data traffic, that is to say a communication between the two selected devices, is in each case described, by way of an illustration, by the number of data packets transmitted or received, respectively, in accordance with the UDP protocol within a predetermined time interval.

For each application and for each pair of devices, that is to say for all possible combinations of application/devices in the telecommunication network 100, the following communication parameters are in each case determined in the manner described above, on the basis of a number of data packets received from the respective device, that is to say arriving at the respective device, in each case within a 5-second interval by using different pretransformations, that is to say data packets subjected to a corresponding preprocessing of the communication parameters:

the number of data packets, but averaged over a number of 5-second intervals and optionally normalized by a normalization function;

a correlation value of the data packets exchanged between the devices over 30 seconds, that is to say over six 5-second intervals or, respectively, 100 seconds, that is to say over twenty 5-second intervals.

The correlation value Corr(x, y, n) determined is determined in accordance with the following rule:

$$Corr ( x , y , n ) = \frac{{\sum }_{i = 0}^{n - 1} ( {x}_{t - i} - \overline{x} ) \cdot ( {y}_{t - i} - \overline{y} )}{\sqrt{( {\sum }_{i = 0}^{n - 1} {( {x}_{t - i} - \overline{x} )}^{2} ) \cdot ( {\sum }_{i = 0}^{n - 1} {( {y}_{t - i} - \overline{y} )}^{2} )}} , \qquad ( 1 )$$

where

n designates the number of values taken into consideration, thus n=6 in the case of 30 seconds and n=20 in the case of 100 seconds,

x is the respective number of received data packets of the first device at the time correspondingly taken into consideration,

y is the respective number of received data packets of the second device at the time correspondingly taken into consideration,

\overline{x}, \overline{y} in each case designates the sliding mean of the last n values (t−n+1) up to the time t of the first or, respectively, second device.

the absolute value of the difference of the in each case incoming packets of the first device of the pair of devices and of the second device of the pair of devices which is in each case being considered;

the minimum value of the number of data packets arriving at one of the two devices of the pair of devices during in each case one 5-second interval.

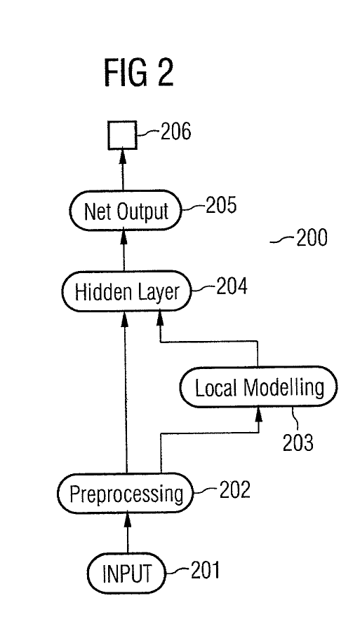

Using the communication parameters determined, which are determined for a multiplicity of training intervals, a training data item is determined in each case for one training interval and supplied to the neural network 200, shown in FIG. 2, for training it.

The neural network 200 has an input layer 201 with ten input neurons which are coupled via in each case a one-to-one link as identity map to a preprocessing layer 202 which also has ten neurons.

In each case, one neuron of the preprocessing layer 202 is coupled to one neuron of the input layer 202.

Furthermore, a local modeling layer 203, described, for example, in G. B. Orr, “Neural Networks: Tricks of the Trade”, Lecture Notes in Computer Science, Vol. 1524, K. R. Müller (ed.), published in 1998 in Berlin by Springer, is coupled to the neurons of the preprocessing layer 202.

A hidden layer 204 with a basically arbitrary number of neurons is coupled both to the neurons of the preprocessing layer 202 and to the neurons of the local modeling layer 203. Furthermore, the hidden layer 204 is coupled via the outputs of its neurons to neurons of an output layer 205 which generate output values 206.

The neural arrangement 200 is trained in the usual manner, for example by a back-propagation training method, using a pruning method as described, for example, by Orr.

In each case, one neural network 200 of the structure shown in FIG. 2 is provided for each pair of devices of the devices contained in the telecommunication network 100 and the neural network 200 is correspondingly trained for this pair of devices in the manner described above.

The neural network 200 thus makes it possible to model both local relationships and global relationships of the communication performance of the respective pair of devices.

If m devices are coupled to one another via the telecommunication network 100,

$$\frac{{( m - 1 )}^{2}}{2}$$

combinations of data must be collected and supplied to the neural network 200 for training.

The neural network 200 trained in accordance with the method described above is copied and thus provides an output for each pair of devices when the input data are applied. Naturally, a number of different, specialized neural networks can also be used. The method described above can thus be performed for each pair of devices of the devices in the telecommunication network as shown in step 402 of the flowchart 400.

As an alternative, a separate neural network can be trained in each case for different combinations of device types in order to increase the accuracy.

The result of step 402 is then a number of

$$\frac{{( m - 1 )}^{2}}{2}$$

of equal or different neural networks 200 (with m different types of devices) which have been trained in the manner described above.

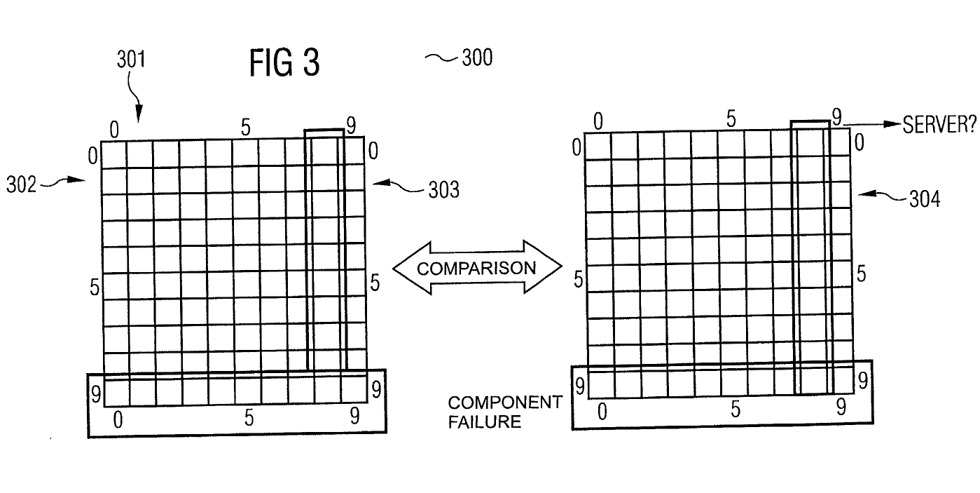

On the basis of the output characteristics of these neural networks 200 for different training data, an output structure is determined and stored, for example, in the form of a matrix 300 as shown in FIG. 3.

FIG. 3 shows in a matrix 300 in each case in a column 301 or, respectively, a row 302 of the matrix 300 which in each case represents a device in the telecommunication network 100, in each case one field, the degree of dependence of the network traffic, that is to say of the incoming data packets due to the trained neural networks 200 which in each case specify the dependence of the data traffic between the individual pairs of devices.

The fields can be described both via a graphical representation and via a predeterminable numerical value which represents the degree of dependence of the data traffic.

In FIG. 3, for illustration purposes, a different degree of dependence of the different network activities of the respective pairs of devices is in each case entered by different shading or hatching.

This results in a graphical structure of dependence which will be called training map 303 in the further text.

A second neural model, a neuro-fuzzy model according to the exemplary embodiment, is then used for learning, by known training methods, the training map 303 determined from the training data from the training phase, which describes the dependences from the training phase.

During the application phase, the corresponding activity parameters are continuously determined and an application map 304 is determined in the same manner described above as the training map 303 has been determined during the training method.

Naturally, not every device is individually examined in each case with another device as a pair of devices in the application phase but in each case the incoming data packets are determined at the respective device for the corresponding time intervals. This is done in each case by using the respective address information in the data packets which can be determined by the transmitter or receiver of the data packet as a result of which the corresponding correlations between the individual pairs of devices are determined in the application phase.

The pattern resulting in the application phase as the application map 304 is compared with the training map 303 by the neuro-fuzzy model in a further step (step 404).

If the application map 304, according to a predetermined similarity criterion, differs more than a predetermined threshold value which can have a tolerance range, an alarm signal is generated (step 405) to indicate that a noticeable network activity has been determined at at least one device or service in the telecommunication network 100 on the basis of a difference in the map structure of the application map 304 compared with the training map 303.

Thus, on the basis of this result of the comparison which leads to the alarm signal, it is possible to deduce the failure of one or more devices in the telecommunication network 100 or that an attempted attack on another device in the telecommunication network 100 is started from one device or that an unauthorized attempt at accessing, that is to say an attempted attack, a device is being undertaken.

If no noticeable network activity is determined in the test step 404, the monitoring method is carried out in a new application phase (step 403) in a repeated determination of an application map 304.

The method is carried out until it is either terminated by the user of the network administration system, that is to say the user of the central administration unit 113 or until the alarm signal has been generated (step 405).

What is claimed is:

1. A method for computer-aided monitoring of a telecommunication network formed of devices capable of communication, said method comprising:
determining activity parameters, each describing activity of at least one of a corresponding device and a corresponding service;
comparing the activity parameters by a statistical estimator trained with training data and having a normal range of dependence based on dependences determined between the devices; and
determining from said comparing whether at least one of the devices and services in the telecommunication network has a communication performance different from the normal range of dependence in accordance with a predetermined criterion.

2. The method as claimed in claim 1, wherein at least some of the devices are constructed as terminals capable of communication.

3. The method as claimed in claim 1, wherein the activity parameters are determined within a predetermined time interval.

4. The method as claimed in claim 1,
wherein said determining of each activity parameter is performed by the corresponding device, and
wherein said method further comprises transmitting the activity parameters to an administration unit which performs said comparing and determining based on said comparing.

5. The method as claimed in claim 1, wherein said determining of each activity parameter is performed by an activity parameter determining unit separate from the corresponding devices.

6. The method as claimed in claim 1, further comprising determining communication-dependent dependences between at least some of the devices and services.

7. The method as claimed in claim 1, further comprising determining possible directional dependences with regard to directions of communication between at least some of the devices and services.

8. The method as claimed in claim 1,
further comprising determining data of at least some of the devices and services, and
wherein said determining of the activity parameters is based on the data.

9. The method as claimed in claim 1, wherein said determining of the activity parameters uses all possible pairs of the devices and pairs of services.

10. The method as claimed in claim 9, further comprising:
storing the activity parameters determined from the pairs of devices in a matrix; and
determining the normal range of dependence from a structure of the matrix.

11. The method as claimed in claim 1, wherein at least one of the following parameters is determined as one of the activity parameters
data packets sent or received by the at least one of a corresponding device and a corresponding service,
processor utilization of the corresponding device,
a number of predetermined system function calls, and
existence of at least one of predetermined processes and predetermined computer programs.

12. The method as claimed in claim 1, wherein a neuro-fuzzy model is used as the statistical estimator.

13. The method as claimed in claim 1, further comprising generating an alarm signal when at least one device in the telecommunication network differs from the normal range of dependence in accordance with the predetermined criterion.

14. The method as claimed in claim 1, further comprising at least one of
determining a disturbance of one of the devices in the telecommunication network;
determining an unauthorized attempt to access one of the devices; and
determining an unauthorized access attempt by one of the devices.

15. A method for computer-aided training of a statistical estimator for administering a telecommunication network formed of devices capable of communication, said method comprising:
determining activity parameters, each describing activity of at least one of a corresponding device and a corresponding service;
determining possible dependences between the devices and services from the activity parameters; and
determining from the possible dependences a normal range of dependence for at least some of the devices and services in essentially undisturbed states to train the statistical estimator.

16. The method as claimed in claim 15, wherein at least some of the devices are constructed as terminals capable of communication.

17. The method as claimed in claim 15, wherein the activity parameters are determined within a predetermined time interval.

18. The method as claimed in claim 15,
wherein said determining of each activity parameter is performed by the corresponding device, and
wherein said method further comprises transmitting the activity parameters to an administration unit which performs said determining of the possible dependences and the normal range of dependence.

19. The method as claimed in claim 15, wherein said determining of each activity parameter is performed by an activity parameter determining unit separate from the corresponding devices.

20. The method as claimed in claim 15, further comprising determining communication-dependent dependences between at least some of the devices and services.

21. The method as claimed in claim 15, further comprising determining possible directional dependences with regard to directions of communication between at least some of the devices and services.

22. The method as claimed in claim 15,
further comprising determining data of at least some of the devices and services, and
wherein said determining of the activity parameters is based on the data.

23. The method as claimed in claim 15, wherein said determining of the activity parameters uses all possible pairs of the devices and pairs of services.

24. The method as claimed in claim 23,
further comprising storing the activity parameters determined from the pairs of devices in a matrix, and
wherein said determining of the normal range of dependence is based on a structure of the matrix.

25. The method as claimed in claim 15, wherein at least one of the following parameters is determined as one of the activity parameters
data packets sent or received by the at least one of a corresponding device and a corresponding service,
processor utilization of the corresponding device,
a number of predetermined system function calls, and
existence of at least one of predetermined processes and predetermined computer programs.

26. A method as claimed in claim 15, wherein a neuro-fuzzy model is used as the statistical estimator.

27. A device for computer-aided monitoring of a telecommunication network formed of devices capable of communication, comprising:
at least one processor to determine activity parameters, each describing activity of at least one of a corresponding device and a corresponding service, to compare the activity parameters by a statistical estimator trained with training data and having a normal range of dependence based on dependences determined between the devices, and to determine from said comparing whether at least one of the devices and services in the telecommunication network has a communication performance different from the normal range of dependence in accordance with a predetermined criterion.

28. At least one computer-readable storage medium storing at least one computer program for computer-aided monitoring of a telecommunication network formed of devices capable of communication, to control a processor to perform a method comprising:
determining activity parameters, each describing activity of at least one of a corresponding device and a corresponding service;
comparing the activity parameters by a statistical estimator trained with training data and having a normal range of dependence based on dependences determined between the devices; and
determining from said comparing whether at least one of the devices and services in the telecommunication network has a communication performance different from the normal range of dependence in accordance with a predetermined criterion.

28. At least one computer-readable storage medium storing at least one computer program for computer-aided training of a statistical estimator for administering a telecommunication network formed of devices capable of communication, to control a processor to perform a method comprising:
determining activity parameters, each describing activity of at least one of a corresponding device and a corresponding service;
determining possible dependences between the devices and services from the activity parameters; and
determining from the possible dependences a normal range of dependence for at least some of the devices and services in essentially undisturbed states to train the statistical estimator.
